(19) United States
(12) Patent Application Publication
(10) Pub. No.: US 2026/0111230 A1
(43) Pub. Date: Apr. 23, 2026

(54) PROCESSOR

(71) Applicant: Arm Limited, Cambridge (GB)

(72) Inventors: Andreas Herman HANSSON, Lund (SE); Elliot Maurice Simon ROSEMARINE, London (GB); Dominic Hugo SYMES, Cambridge (GB); Jens OLSON, San Jose, CA (US)

(21) Appl. No.: 18/919,168

(22) Filed: Oct. 17, 2024

(51) Int. Cl. G06F 9/30; G06F 7/487; G06F 7/76

(52) U.S. Cl. CPC G06F 9/30043; G06F 7/4876; G06F 7/764; G06F 9/30036

(57) ABSTRACT

A processor comprises a handling unit configured to issue invocation data to a storage access controller to load multi-dimensional bricks from the tensor. The multidimensional bricks comprise a brick of primary data and a brick of auxiliary data. The storage access controller configured to: identify a location of the brick of primary data in the storage of the processor using one or more stride of the primary data in one or more dimension of the tensor, load the brick of primary data from the identified location, determine one or more virtual strides for one or more dimensions of the auxiliary data based on the one or more strides of the primary data, identify a location of the brick of auxiliary data in the first storage using the determined one or more virtual strides, and load the brick of the auxiliary data from the identified location.

### BACKGROUND OF THE INVENTION

### Field of the Invention

The present invention relates to a processor and a method performed by a processor.

### Description of the Related Technology

An NPU (neural processing unit) is a specialized piece of hardware designed to optimize the performance of tasks related to artificial intelligence and neural networks. NPUs are increasingly common and are used for tasks such as autonomous driving and natural language processing, as well as face recognition, and voice recognition. NPUs typically include many processing elements and associated control structures that allow efficient processing of the numerous calculations in neural network and machine learning workloads.

GPU (graphics processing units) were originally developed for rendering graphics in video games and multimedia applications. GPU typically have hardware that is optimized for graphics processing tasks such as rendering graphics, simulating physics (e.g. ray tracing), and other tasks that require parallel processing. GPU may also find applications in processing tasks relates to artificial intelligence and neural networks.

Data processing techniques, such as neural network processing and graphics processing, involve the processing and generation of considerable amounts of data using operations. It is desirable to efficiently handle this data when processing the data using an operation set.

### SUMMARY

According to a first aspect there is provided a processor comprising a neural processing unit, wherein the neural processing unit comprises: a handling unit configured to: obtain a description of a task that involves data in a multi-dimensional tensor in a storage, and issue invocation data to a storage access controller to load multi-dimensional bricks from the tensor, wherein the multidimensional bricks comprise a brick of primary data read from a first segment of the tensor and a brick of auxiliary data read from a second segment of the tensor;
the storage access controller configured to: receive the invocation data from the handling unit; identify a location of the brick of primary data in the storage using one or more stride of the primary data in one or more dimension of the tensor, load the brick of primary data from the identified location in the storage, determine one or more virtual strides for one or more dimensions of the auxiliary data based on the one or more strides of the primary data, identify a location of the brick of auxiliary data in the storage using the determined one or more virtual strides, and load the brick of the auxiliary data from the identified location in the storage.

According to a second aspect there is provided a method performed by a processor comprising a neural processing unit, wherein the method comprises: obtaining, by a handling unit of the neural processing unit, a description of a task that involves data in a multi-dimensional tensor in a storage; issuing, by the handling unit to a storage access controller, invocation data to read multi-dimensional bricks from the tensor, wherein the multidimensional bricks comprise a brick of primary data read from a first segment of the tensor and a brick of auxiliary data read from a second segment of the tensor; receiving, by the storage access controller, the invocation data from the handling unit; identifying, by the storage access controller, a location of the brick of primary data in the storage using one or more stride of the primary data in one or more dimension of the tensor, loading, by the storage access controller, the brick of primary data from the identified location in the storage, determining, by the storage access controller, one or more virtual strides for one or more dimensions of the auxiliary data based on the one or more strides of the primary data, identifying, by the storage access controller, a location of the brick of auxiliary data in the storage using the determined one or more virtual stride, and loading, by the storage access controller, the brick of the auxiliary data from the identified location in the storage.

### BRIEF DESCRIPTION OF THE DRAWINGS

Further features and advantages will become apparent from the following description of preferred embodiments, given by way of example only, which is made with reference to the accompanying drawings in which like reference numerals are used to denote like features.

FIG. 1a illustrates an example directed graph in which sections are interconnected by a series of pipes;

FIG. 1b is a schematic diagram of a data processing system;

FIG. 2 is a schematic diagram of a neural engine;

FIG. 3 shows schematically an example system for allocating handling data;

FIG. 4 illustrates an example progression of operations to be performed;

FIG. 5 illustrates an example coordinate space corresponding to FIG. 4;

FIG. 6 illustrates an example of scheduling of the blocks shown in FIG. 5;

FIG. 7 is a flow-chart of efficient data processing;

FIG. 8 shows logic for determining a virtual stride;

FIG. 9 is a flow chart showing steps performed by a storage access controller; and

FIG. 10 illustrates manufacture of a system and a chip-containing product.

### DETAILED DESCRIPTION OF CERTAIN INVENTIVE EMBODIMENTS

Examples herein relate to a processor for handling data, the processor comprising a handling unit, a plurality of storage elements, and a plurality of execution units. The processor is configured to obtain, from storage, task data that describes a task to be executed in the form of a directed graph of operations. Each of the operations maps to a corresponding execution unit of the processor. Each connection between operations in the directed graph maps to a corresponding storage element of the processor. The task data further defines an operation space representing the dimensions of a multi-dimensional arrangement of the connected operations to be executed.

For each of a plurality of portions of the operation space, the processor is configured to transform the portion of the operation space to generate respective operation-specific local spaces for each of the plurality of the operations of the graph.

The processor is further configured to dispatch, to each of a plurality of the execution units associated with operations for which transformed local spaces have been generated, invocation data describing the operation-specific local space, and at least one of a source storage element (logically referred to as a source pipe) and a destination storage element (logically referred to as a destination pipe) corresponding to a connection between the particular operation that the execution unit is to execute and a further adjacent operation in the directed graph to which the particular operation is connected.

The present disclosure relates to executing a directed graph of operations (referred to as sections) connected by various connections (referred to as pipes). By providing the capability to operate upon a sequence of connected operations (sections) that can be defined within an operation space common to the sequence of operations, it can be guaranteed that all coordinates required by the operations within the operation space are reachable when executing that sequence of operations. For each execution of an operation (or portion of an operation), the operation space is transformed into a local section space for that operation.

Each operation (section) is linked by corresponding pipes to form a directed graph of operations. For each operation, source and destination pipes can be defined and, under the control of a handling unit, the execution of sections can be issued by issuing invocation data that defines in the source and destination pipes for the operation. This execution of the graph of operation by respective execution units is therefore implicitly ordered by the dependencies on specific inputs to the operation. The result of this implicit ordering being a simplified orchestration of operations amongst the execution units of the processor. Put another way, sections and their directed relationship to each other can be determined by their pipe usage (e.g. their producers/consumers).

Different operations having different types are linked together by defining the common operation-space for the whole graph (or progression of operations), and then defining transforms from the operation-space to each operation's individual section-space. Now each hardware unit only needs to understand their fixed-function transform from section-space to input/output spaces, without needing to understand the progression of operations preceding or succeeding it. For example, it is possible to link additional operations in front of or after a convolution operation and stitch a wider variety of operations together, provided that the conditions of a valid operation space exist. Since all sections are iterating through the same operation-space in execution, blocks of data are aligned. For example, a first block from a memory read operation will be the first block into the data processing operation, and this will trickle through to the first block in the memory write operation. This is a simplification given that for some operations (reduction and broadcast operations) since the block may be grouped with data from other blocks to form a new merged block, but generally holds as a principle. Operation-space is typically mapped to a specific operation's space in the graph, with programmatic transforms provided for all other operations.

Operations accessing pipes might have an additional transform to access data stored in pipes. For example, this might be a different transform for the different pipes: different for multiple inputs, different for outputs. This transform is defined in the nature of the operation and is fixed function.

In summary, an operation's section space might be mapped to input and/or output (they can be the same), or operation's section space might be mapped separately in which case a fixed function transform might be needed. In this way, the proposed approach allows for more compartmentalized functionality in separate execution units. The execution units of the processor can therefore be implemented in a more simplified structure since there is no need to provide the capability in each execution unit to perform complex transforms on the front-end or output of the execution units. Instead, the transformation from operation space to section space (and therefore the management of compatibility and correct structuring of data between consecutive operations) is managed and issued centrally by a single handling unit based upon the dimensionality of a pre-defined operation space—e.g. by a descriptor that defines the operation space and the sections and pipes that form the graph.

Since the single transform unit can execute the transforms from operation to section-space, the processor is able to add support for additional operations in the future without the need for significant hardware modification to the execution units to allow additional operations to be linked in front of or in any place in a progression. This allows new functionality to be added easily. As an example: for a convolution operation, dynamic weights can be added easily by adding a data re-ordering unit or transform capable of transforming a tensor in an activation layout into a weight layout, which can be handled by a convolution engine. Attributes of operations such as padding around the edges of an input can also be implemented through the transform mechanism.

In some examples, the processor is optionally configured such that each execution unit of the plurality of execution units of the processor is configured to perform a specific operation type and wherein the mapping between operations in the directed graph and the execution units is defined based upon compatibility of execution between the operation in directed graph and the specific operation type of the execution unit.

In some examples, the processor is optionally configured such that the task data comprises an element-count value indicating a count of a number of elements mapping to each execution unit having a specific operation type, wherein each element corresponds to an instance of use of an execution unit in order to execute each operation in the directed graph; and a pipe-count value indicating a count of the number of pipes needed to execute the task. There exists an element to describe each type of section and each type of pipe and so an element may be defined as a structured definition of a pipe or section. As described herein, a section has various parameters that describe the specifics of an execution.

In some examples, the processor is optionally configured such that the task data further comprises, for each element in the directed graph, element configuration data defining data used to configure the particular execution unit when executing the operation.

In some examples, the processor is optionally configured such that the element configuration data comprises an offset value pointing to a location in memory of transform data indicating the transform to the portion of the operation space to be performed to generate respective operation-specific local spaces for each of the plurality of the operations of the directed graph.

In some examples, the processor is optionally configured such that the task data comprises transform program data defining a plurality of programs, each program comprising a sequence of instructions selected from a transform instruction set. The processor is optionally configured such that the transform program data is stored for each of a pre-determined set of transforms from which a particular transform is selected to transform the portion of the operation space to generate respective operation-specific local spaces for each of the plurality of the operations of the directed graph.

In some examples, the processor is optionally configured such that the transform program data is configured to perform the particular transform upon a plurality of values stored in boundary registers defining the operation space to generate new values in the boundary registers.

The processor may be configured to iterate over the operation space in blocks, wherein the blocks are created according to a pre-determined block size.

In some examples, the processor is optionally configured such that dispatch of invocation data is controlled based upon a value identifying the dimensions of the operation space for which changes of coordinate in said dimensions while executing the task causes the operation to execute, and a further value identifying the dimensions of the operation space for which changes of coordinate in said dimensions while executing the task causes the operation to store data in the storage, wherein the stored data being ready to be consumed by an operation.

### Execution of a Directed Graph (DG)

Many data structures to be executed in a processor can be expressed as a directed graph. Examples of such data structures include neural networks which can be represented as a directed graph of operations that wholly compose the operations required to execute a network (i.e. to execute the operations performed across the layers of a neural network). A directed graph is a data structure of operations (herein also referred to as ‘sections’) having directed connections therebetween that indicate a flow of operations. The connections between operations (or sections) present in the graph of operations are also to referred herein as ‘pipes’. A directed graph may contain any number of divergent and convergent branches.

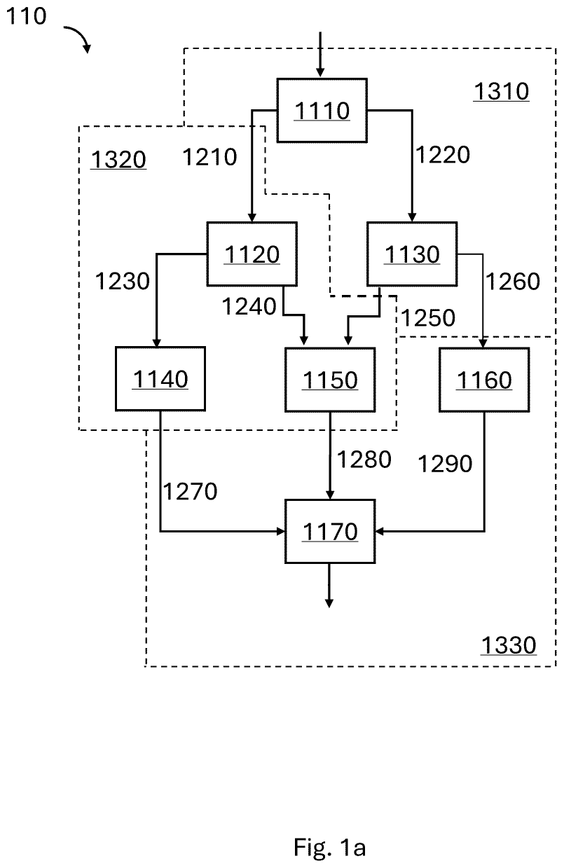

FIG. 1a illustrates an example directed graph in which sections are interconnected by a series of pipes. Specifically, an initial section, section 1 (1110) represents a point in the directed graph at which an operation, operation A, is to be performed when executing the graph. The output of operation A at section 1, 1110, is connected to two further sections, section 2 (1120) and section 3 (1130) at which respective operations B and C are to be performed. The connection between section 1 (1110) and section 2 (1120) can be identified as a pipe with a unique identifier, pipe 1 (1210). The connection between section 1 (1110) and section 3 (1130) can be identified as a pipe with a different unique identifier, pipe 2 (1220). The output of section 1, which is the result of performing operation A on the input to section 1, can be provided to multiple subsequent sections in a branching manner.

More generally, sections in the directed graph may receive multiple inputs, each from a respective different section in the directed graph via a respective different pipe. For example, section 1150 in FIG. 1a receives a first set of input data via pipe 1240 from section 1120 and a second set of input data via pipe 1250. Depending on the nature of the operation performed in a particular section and the dependencies of subsequent operations on the output of the operation, any number of input and output pipes may be connected to a particular section in the directed graph.

The directed graph can be represented by a number of sub-graphs each containing a subset of the sections in the graph. FIG. 1a illustrates an arrangement where the graph 110 is broken down into three sub-graphs 1310, 1320, and 1330 which can be connected together to form the complete graph. For example, sub-graph 1310 contains sections 1110 and 1130 (as well as the corresponding pipes 1220 and 1260), sub-graph 1320 contains sections 1120, 1140, and 1150 (as well as corresponding pipes 1210, 1230, 1240, and 1250), and sub-graph 1330 contains sections 1160 and 1170 (as well as corresponding pipes 1270, 1280, and 1290).

The deconstruction of a graph 110 into sub-graphs is particularly useful when seeking to execute the graph since it would be possible to separately execute the sub-graphs which allows for parallelization of execution where there are no dependencies between sub-graphs. This can be particularly useful in a multi-processor environment where sub-graphs can be allocated for execution by different processors in the multi-processor environment. However, as shown in FIG. 1a, sub-graph 1320 has a dependency on the execution of operation A and section 1110 and sub-graph 1330 has a dependency on sub-graph 1310. As such, execution of sub-graph 1330 may need to be stalled until sub-graph 1310 has been completed. It will therefore be appreciated that it is necessary to carefully select the appropriate sub-graph arrangement to maximize or improve the execution efficiency of the graph.

The operations performed when executing a neural network can be broken down into a sequence of operations forming a directed graph in the form described in respect of FIG. 1a. The detailed description herein will describe an arrangement for executing a directed graph of operations in an improved manner.

### Operation Space

When executing progressions of operations, for example structured in a directed graph, each section could represent a different operation. It is not necessary for each operation to be of the same type or nature. This is particularly the case where the graph of operations is used to represent the processing of a neural network. The machine learning software ecosystem allows for a diverse structure of neural networks that are applicable to many different problem spaces, and as such there is a very large possible set of operators from which a neural network can be composed. The possible set of operations from which sections can be formed can be hard to manage when seeking to design hardware to enable the execution (also referred to as “acceleration”) of these operations—particularly when linked together. For example, enabling fixed-function operation of each possible type of operation can result in inefficient hardware by requiring support for obscure or complex operations (sections).

As a result, there are significant challenges in designing and building hardware capable of executing all types of neural networks created by the current machine learning toolsets. It is desirable to define a set of pre-determined low-level operations from which a broad range of possible higher-level operations that correspond with various machine learning tool sets can be built. One example of such a low-level set of operations, is the Tensor Operator Set Architecture (TOSA). The Tensor Operator Set Architecture (TOSA) provides a set of whole-tensor operations commonly employed by Deep Neural Networks. The intent is to enable a variety of implementations running on a diverse range of processors, with the results at the TOSA level consistent across those implementations. Applications or frameworks which target TOSA can therefore be deployed on a wide range of different processors, including single-instruction multiple-data (SIMD) CPUs, graphics processing units (GPUs) and custom hardware such as neural processing units/tensor processing units (NPUs/TPUs), with defined accuracy and compatibility constraints. Most operators from the common ML frameworks (TensorFlow, PyTorch, etc.) should be expressible in TOSA.

However, even with such operator sets existing, there is a need to implement the operator sets in a manner that can be executed efficiently, both in terms of complexity and while minimizing the need to perform external memory transactions. To enable this, it is useful to consider that many of the operations in a defined operation set (such as TOSA) can be represented as a loop of scalar operations.

### Hardware Implementation

As described above, a data structure in the form of a directed graph may comprise plural sequenced operations that are connected to one another for execution in a progression. Described below is an example hardware arrangement for executing linked operations for at least a portion of a directed graph as illustrated in FIG. 1a.

FIG. 1b shows schematically an example of a data processing system 600 including processor 630 which may act as a co-processor or hardware accelerator unit for a host processing unit 610. It will be appreciated that the types of hardware accelerator which the processor 630 may provide dedicated circuitry for is not limited to that of Neural Processing Units (NPUs) or Graphics Processing units (GPUs) but may be dedicated circuitry for any type of hardware accelerator. GPUs may be well-suited for performing certain types of arithmetic operations such as neural processing operations, as these operations are generally similar to the arithmetic operations that may be required when performing graphics processing work (but on different data formats or structures). Furthermore, GPUs typically support high levels of concurrent processing (e.g. supporting large numbers of execution threads), and are optimized for data-plane (rather than control plane) processing, all of which means that GPUs may be well-suited for performing other types of operations.

That is, rather than using entirely separate hardware accelerators, such as a machine learning processing unit that is independent of the graphics processor, such as an NPU, or only being able to perform machine learning processing operations entirely using the hardware of the GPU, dedicated circuitry may be incorporated into the GPU itself.

This means that the hardware accelerator circuitry incorporated into the GPU is operable, to utilize some of the GPU's existing resources (e.g. such that at least some functional units and resource of the GPU can effectively be shared between the different hardware accelerator circuitry, for instance), whilst still allowing an improved (more optimized) performance compared to performing all the processing with general purpose execution.

As such, the processor 630 may be a GPU that is adapted to comprise a number of dedicated hardware resources, such as those which will be described below.

In some examples, this can be particularly beneficial when performing machine learning tasks that themselves relate to graphics processing work, as in that case all of the associated processing can be (and preferably is) performed locally to the graphics processor, thus improving data locality, and (e.g.) reducing the need for external communication along the interconnect with other hardware units (e.g. an NPU). In that case, at least some of the machine learning processing work can be offloaded to the machine learning processing circuit, thereby freeing the execution unit to perform actual graphics processing operations, as desired.

In other words, in some examples, providing a machine learning processing circuit within the graphics processor, this means that the machine learning processing circuit is preferably then operable to perform at least some machine learning processing operations whilst the other functional units of the graphics processor are simultaneously performing graphics processing operations. In the situation where the machine learning processing relates to part of an overall graphics processing task this can therefore improve overall efficiency (in terms of energy efficiency, throughput, etc.) for the overall graphics processing task.

In FIG. 1b, the processor 630 is arranged to receive task data 620 from a host processor 610, such as a central processing unit (CPU). The task data comprises at least one command in a given sequence, each command to be executed, and each command may be decomposed into a number of tasks, such as tasks discussed in this document. These tasks may be self-contained operations, such as a given machine learning operation or a graphics processing operation. It will be appreciated that there may be other types of tasks depending on the command.

The task data 620 is sent by the host processor 610 and is received by a command processing unit 640 which is arranged to schedule the commands within the task data 620 in accordance with their sequence. The command processing unit 640 is arranged to schedule the commands and decompose each command in the task data 620 into at least one task. Once the command processing unit 640 has scheduled the commands in the task data 620, and generated a plurality of tasks for the commands, the command processing unit 640 issues each of the plurality of tasks to at least one compute unit 650a, 650b each of which are configured to process at least one of the plurality of tasks.

The processor 630 comprises a plurality of compute units 650a, 650b. Each compute unit 650a, 650b, may be a shader core of a GPU specifically configured to undertake a number of different types of operations, however it will be appreciated that other types of specifically configured processor may be used, such as a general-purpose processor configured with individual compute units, such as compute units 650a, 650b. Each compute unit 650a, 650b comprises a number of components, and at least a first processing module 652a, 652b for executing tasks of a first task type, and a second processing module 654a, 654b for executing tasks of a second task type, different from the first task type. In some examples, the first processing module 652a, 652b may be a processing module for processing neural processing operations, such as those which would normally be undertaken by a separate NPU. In these cases, the first processing module 652a, 652b is for example a neural engine. Similarly, the second processing module 654a, 654b may be a processing module for processing graphics processing operations forming a set of pre-defined graphics processing operations which enables the implementation of a graphics processing pipeline, which may be referred to as a graphics processor. For example, such graphics processing operations include a graphics compute shader task, a vertex shader task, a fragment shader tasks, a tessellation shader task, and a geometry shader task. These graphics processing operations may all form part of a set of pre-defined operations as defined by an application programming interface, API. Examples of such APIs include Vulkan, Direct3D and Metal. Such tasks would normally be undertaken by a separate/external GPU. It will be appreciated that any number of other graphics processing operations may be capable of being processed by the second processing module.

As such, the command processing unit 640 issues tasks of a first task type to the first processing module 652a, 652b of a given compute unit 650a, 650b, and tasks of a second task type to the second processing module 654a, 654b of a given compute unit 650a, 650b. The command processing unit 640 would issue machine learning/neural processing tasks to the first processing module 652a, 652b of a given compute unit 650a, 650b where the first processing module 652a, 652b is optimized to process neural network processing tasks, for example by comprising an efficient means of handling a large number of multiply-accumulate operations. Similarly, the command processing unit 640 would issue graphics processing tasks to the second processing module 654a, 654b of a given compute unit 650a, 650b where the second processing module 652a, 654a is optimized to process such graphics processing tasks. In some examples, the first and second may both be neural processing tasks issued to a first processing module 652a, 652b, which is a neural engine. Such a neural processing task may involve the processing of a tensor, e.g. representing a feature map, with weights associated with a layer of a neural network.

In addition to comprising a first processing module 652a, 652b and a second processing module 654a, 654b, each compute unit 650a, 650b also comprises a memory in the form of a local cache 656a, 656b for use by the respective processing module 652a, 652b, 654a, 654b during the processing of tasks. Examples of such a local cache 656a, 656b is a L1 cache. The local cache 656a, 656b may, for example, a synchronous dynamic random-access memory (SDRAM). For example, the local cache 656a, 656b may comprise a double data rate synchronous dynamic random-access memory (DDR-SDRAM). It will be appreciated that the local cache 656a, 656b may comprise other types of memory.

The local cache 656a, 656b is used for storing data relating to the tasks which are being processed on a given compute unit 650a, 650b by the first processing module 652a, 652b and second processing module 654a, 654b. It may also be accessed by other processing modules (not shown) forming part of the compute unit 650a, 650b the local cache 656a, 656b is associated with. However, in some examples, it may be necessary to provide access data associated with a given task executing on a processing module of a given compute unit 650a, 650b to a task being executed on a processing module of another compute unit (not shown) of the processor 630. In such examples, the processor 630 may also comprise storage 660, for example a cache, such as an L2 cache, for providing access to data use for the processing of tasks being executed on different compute units 650a, 650b.

By providing a local cache 656a, 656b tasks which have been issued to the same compute unit 650a, 650b may access data stored in the local cache 656a, 656b, regardless of whether they form part of the same command in the task data 620. The command processing unit 640 is responsible for allocating tasks of commands to given compute units 650a, 650b such that they can most efficiently use the available resources, such as the local cache 656a, 656b, thus reducing the number of read/write transactions required to memory external to the compute units 650a, 650b, such as the storage 660 (L2 cache) or higher level memories. One such example, is that a task of one command issued to a first processing module 652a of a given compute unit 650a, may store its output in the local cache 656a such that it is accessible by a second task of a different (or the same) command issued to a given processing module 652a, 654a of the same compute unit 650a.

One or more of the command processing unit 640, the compute units 650a, 650b, and the storage 660 may be interconnected using a bus. This allows data to be transferred between the various components. The bus may be or include any suitable interface or bus. For example, an ARM® Advanced Microcontroller Bus Architecture (AMBA®) interface, such as the Advanced extensible Interface (AXI), may be used.

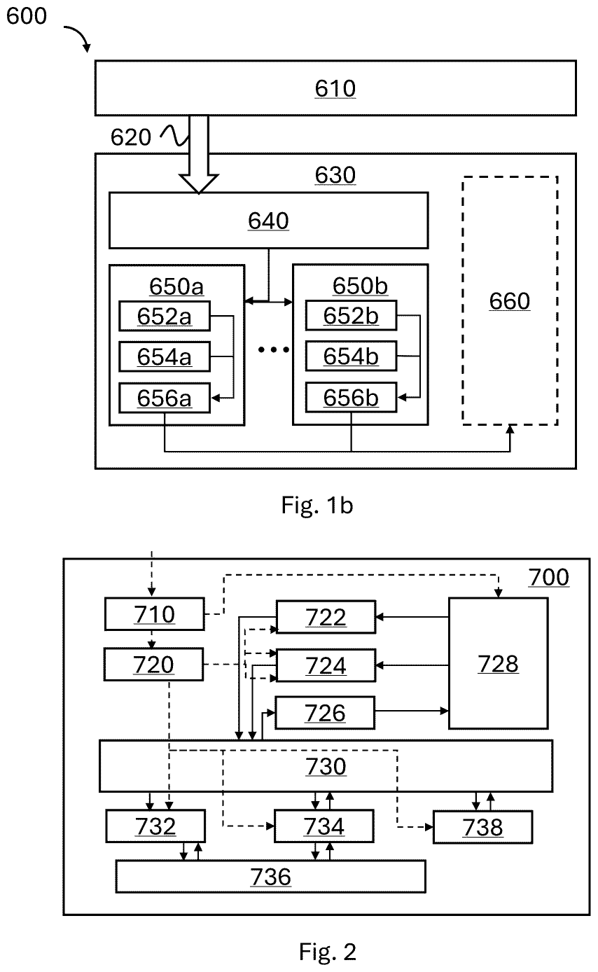

FIG. 2 is a schematic diagram of a neural engine 700, which in this example is used as a first processing module 652a, 652b in a data processing system 600 in accordance with FIG. 1b. The neural engine 700 includes a command and control module 710. The command and control module 710 receives tasks from the command processing unit 640 (shown in FIG. 1b), and also acts as an interface to storage external to the neural engine 700 (such as a local cache 656a, 656b and/or a L2 cache 660) which is arranged to store data to be processed by the neural engine 700 such as data representing a tensor, or data representing a stripe of a tensor. In the context of the present disclosure, a stripe is a subset of a tensor in which each dimension of the stripe covers a subset of the full range of the corresponding dimension in the tensor. The external storage may additionally store other data to configure the neural engine 700 to perform particular processing and/or data to be used by the neural engine 700 to implement the processing such as neural network weights.

The command and control module 710 interfaces to a handling unit 720, which is for example a traversal synchronization unit (TSU). In this example, each task corresponds to one or more tensor which is to be operated upon in accordance with a sequence of operations according to at least a portion (e.g. a sub-graph) of the directed graph representation of the neural network. The tensor for example represents a feature map for processing using the neural network. A neural network typically includes a sequence of layers of processing, with an output from each layer being used as an input to the next layer. Each layer for example processes an input feature map by operating upon the input feature map to generate an output feature map, which is used as the input feature map for the next layer. The term “feature map” is used generically herein to refer to either an input feature map or an output feature map. The processing performed by a given layer may be taken to correspond to an operation.

In this example, the handling unit 720 splits data representing a stripe of a feature map into a plurality of blocks of data, each of which represents a respective part of the feature map. The handling unit 720 also obtains, from storage external to the neural engine 700 such as the L2 cache 660, task data defining operations selected from an operation set comprising a plurality of operations. In this example, the operations are structured as a progression of operations representing a sequence of layers of the neural network. A block of data is allocated as an input to one of the operations by the handling unit 720.

The handling unit 720 coordinates the interaction of internal components of the neural engine 700, which include a weight fetch unit 722, an input reader 724, an output writer 726, a direct memory access (DMA) unit 728, a dot product unit (DPU) array 730, a vector engine 732, a transform unit 734, an accumulator buffer 736, and a shared storage 738, for processing of blocks of data. The data dependencies across the functional units are tracked by the handling unit 720. Processing is initiated by the handling unit 720 in a functional unit if all input blocks are available and space is available in the shared storage 738 of the neural engine 700. The shared storage 738 may be considered to be a shared buffer, in that various functional units of the neural engine 700 share access to the shared storage 738.

In the context of a directed graph representing the operations to be performed, each of the internal components that operates upon data can be considered to be one of two types of component. The first type of component is an execution unit (and is identified within the neural engine 700 as such) that maps to a section that performs a specific instance of an operation within the directed graph. For example, the weight fetch unit 722, input reader 724, output writer 726, dot product unit array 730, vector engine 732, transform unit 734 each are configured to perform one or more pre-determined and fixed operations upon data that it receives. Each of these sections can be uniquely identified with an identifier and each execution unit can also be uniquely identified.

Similarly, all physical storage elements within the neural engine (and in some instances portions of those physical storage elements) can be considered to be uniquely identified within the neural engine. The connections between sections in the directed graph representing the neural network are also referred to as pipes within the context of the directed graph. These pipes can also be mapped to the uniquely identified physical storage elements in the neural engine. For example, the accumulator buffer 736 and shared storage 738 (and portions thereof) can each be regarded as a storage element that can act to store data for a pipe within the directed graph. The pipes act as connections between the sections (as executed by execution units) to enable a sequence of operations as defined in the directed graph to be linked together within the neural engine 700. Put another way, the logical dataflow of the directed graph can be mapped to the physical arrangement of execution units and storage elements within the neural engine 700. Under the control of the handling unit 720, execution can be scheduled on the execution units and data can be passed between the execution units via the storage elements in accordance with the mapping, such that the linked operations of a graph can be executed without needing to write data memory external to the neural engine 700 between executions. The handling unit 720 is configured to control and dispatch work representing performing an operation of the graph on at least a portion of the data provided by a pipe.

The weight fetch unit 722 fetches weights associated with the neural network from external storage and stores the weights in the shared storage 738. The input reader 724 reads data to be processed by the neural engine 700 from external storage, such as a block of data representing part of a tensor. The output writer 726 writes data obtained after processing by the neural engine 700 to external storage. The weight fetch unit 722, input reader 724 and output writer 726 interface with the external storage (which is for example the local cache 656a, 656b, which may be a L1 cache such as a load/store cache) via the DMA unit 728.

Data is processed by the DPU array 730, vector engine 732 and transform unit 734 to generate output data corresponding to an operation in the directed graph. The result of each operation is stored in a specific pipe within the neural engine 700. The DPU array 730 is arranged to perform one or more operations associated with a dot product operation between two operands, such as between an array of weights and a corresponding block of data (e.g. representing part of a tensor). As will be described in further detail below, the vector engine 732 is arranged to perform elementwise operations, for example to apply scale parameters to scale an output of a dot product calculated by the DPU array 730. Data generated during the course of the processing performed by the DPU array 730 and the vector engine 732 may be transmitted for temporary storage in the accumulator buffer 736 which acts as a pipe between the previous operation and the subsequent operation, from where it may be retrieved by either the DPU array 730 or the vector engine 732 (or another different execution unit) for further processing as desired.

The transform unit 734 is arranged to perform in-block transforms such as dimension broadcasts or axis swaps. The transform unit 734 obtains data from a pipe, such as shared storage 738 (e.g. after processing by the DPU array 730 and/or vector engine 732), and writes transformed data back to the shared storage 738.

To make efficient use of the shared storage 738 available within the neural engine 700, the handling unit 720 determines an available portion of the shared storage 738, which is available during execution of part of a first task (e.g. during processing of a block of data associated with the first task by the DPU array 730, vector engine 732 and/or transform unit 734). The handling unit 720 determines a mapping between at least one logical address associated with data generated during execution of a second task (e.g. by processing of a block of data associated with the second task by the DPU array 730, vector engine 732 and/or transform unit 734) and at least one physical address of the shared storage 738 corresponding to the available portion. The logical address is for example a global address in a global coordinate system. Hence, by altering the physical address corresponding to a given logical address, the handling unit 720 can effectively control usage of the shared storage 738 without requiring a change in software defining the operation to be performed, as the same logical address can still be used to refer to a given element of the tensor to be processed. The handling unit 720 identifies the at least one physical address corresponding to the at least one logical address, based on the mapping, so that data associated with the logical address is stored in the available portion. The handling unit 720 can perform the mapping process according to any of the examples herein.

It will be appreciated that in a graph of operations there does not need to be only a single instance of a particular type of operation. For example, multiple instances of a convolution operation could be present in a graph of operations. In the above example hardware arrangement only a single convolution engine may be present. Therefore, it will be appreciated that there does not need to be a direct 1:1 mapping between operations in the graph (sections) and execution units, and similarly no direct 1:1 mapping between pipes and storage elements. In particular, a single execution unit may be configured at different instances in time to execute different instances of a convolution operation (e.g. first and second sections). Similarly, the input reader may be required to read data as part of different sections in the graph. The same can be said for storage elements and pipes.

All storage in the neural engine 700 may be mapped to corresponding pipes, including look-up tables, accumulators, etc. Some storage may be relatively fixed purpose, for example, if the hardware were limited to one convolution operation per graph the accumulator buffer might also be limited to being mapped to one pipe, and scale/bias/shift buffer might be limited to being mapped to one pipe; however both would likely be double buffered. If the neural engine supports 2 look-up tables (LUTs), then a maximum of 2 pipes could be used to target the LUTs to avoid needing to thrash the LUT storage; LUT pipes might then be single buffered. All other pipes could be mapped to a common Shared Buffer (or portions thereof) with fewer restrictions. Width and height of pipe can also be programmable, resulting a highly configurable mapping between pipes and storage elements within the neural engine 700.

Ordering of execution of the sections is implied by dependencies on inputs. A memory load operation generally has no data dependencies, so is implicitly early in the graph. The consumer of the pipe that the memory read produces is implicitly after the memory read. A memory store operation is near the end of the graph, as it produces no pipes for other operations to consume. The sequence of execution of a progression of operations is therefore handled by the handling unit 720 as will be explained in more detail later.

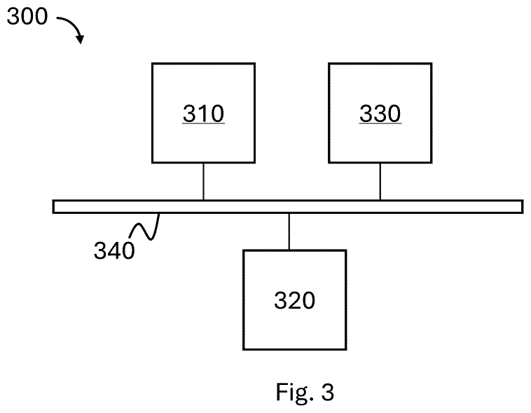

FIG. 3 shows schematically a system 300 for allocating handling data, and in some examples generating a plurality of blocks of input data for processing.

The system 300 comprises host processor 310 such as a central processing unit, or any other type of general processing unit. The host processor 310 issues task data comprising a plurality of commands, each having a plurality of tasks associated therewith.

The system 300 also comprises a processor 330, which may be similar to or the same as the processor 630 of FIG. 1b and may comprise at least some of the components of and/or be configured to perform the methods described above. The processor 330 comprises at least a plurality of compute units 650a, 650b and a command processing unit 640. Each compute unit may comprise a plurality of processing modules each configured to perform at least one type of operation. The system 300 may also include at least one further processor (not shown), which may be the same as the processor 330. The processor 330, and the host processor 310 may be combined as a System on Chip (SoC) or onto multiple SoCs to form one or more application processors.

The system 300 also comprises memory 320 for storing data generated by the tasks externally from the processor 330, such that other tasks operating on other processors may readily access the data. However, it will be appreciated that the external memory usage will be used sparingly, due to the allocation of tasks as described above, such that tasks requiring the use of data generated by other tasks, or requiring the same data as other tasks, will be allocated to the same compute unit 650a, 650b of a processor 330 so as to maximize the usage of the local cache 656a, 656b.

In some examples, the system 300 may comprise a memory controller (not shown), which may be a dynamic memory controller (DMC). The memory controller is coupled to the memory 320. The memory controller is configured to manage the flow of data going to and from the memory. The memory may comprise a main memory, otherwise referred to as a ‘primary memory’. The memory may be an external memory, in that the memory is external to the system 300. For example, the memory 320 may comprise ‘off-chip’ memory. The memory may have a greater storage capacity than local caches of the processor 330 and/or the host processor 310. In some examples, the memory 320 is comprised in the system 300. For example, the memory 320 may comprise ‘on-chip’ memory. The memory 320 may, for example, comprise a magnetic or optical disk and disk drive or a solid-state drive (SSD). In some examples, the memory 320 comprises a synchronous dynamic random-access memory (SDRAM). For example, the memory 320 may comprise a double data rate synchronous dynamic random-access memory (DDR-SDRAM).

One or more of the host processor 310, the processor 330, and the memory 320 may be interconnected using a system bus 340. This allows data to be transferred between the various components. The system bus 340 may be or include any suitable interface or bus. For example, an ARM® Advanced Microcontroller Bus Architecture (AMBAR) interface, such as the Advanced extensible Interface (AXI), may be used.

### Neural Engine Program Descriptor (NED)

The neural engine 700 receives tasks from the command processing unit 640 to execute operations from the directed graph. The neural engine 700 is configured to execute operations selected from a base set of operations defining an operator set. One example of such an operator set is the Tensor Operator Set Architecture (TOSA) base inference profile, which defines a set of operations that can collectively be used to define the operations of a wide range of neural network operations. One exception to the TOSA operator set is control flow operations that may be implemented by way of task data processed by the command processing unit 640. It will be appreciated that there may be multiple neural engines with the processor 630 and thus multiple tasks can be issued concurrently to different neural engines.

In an example implementation, a task issued by the command processing unit 640 for execution by the neural engine 700 is described by task data which in this example is embodied by a neural engine program descriptor (NED), which is a data structure stored in memory and retrieved by the neural engine when executing the task issues by the command processing unit. The NED describes at least a portion of a complete graph of operations (sections) to be performed when executing the graph of operations (e.g. representing a neural network). As discussed above, sections are mapped to various hardware execution units within the neural engine 700 and essentially represent instantiations of a particular operator at a position within the graph. In one example, these sections are described by specific ‘elements’ that collectively define the operations forming part of the NED. Furthermore, the NED has an unordered list of pipes (graph vertices) and an unordered list of sections/operations (graph nodes). Each operation specifies its input and output giving rise to adjacency of operation in the directed graph to which a particular operation is connected. An example NED comprises a NED structure comprising a header, the elements each corresponding to a section in the graph. The NED describes the various requirements of ordering, number and relationship of these sections and pipes. In one implementation, each of the execution units and each storage element (or portion of a storage element) of the neural engine 700 has a sub-descriptor definition which defines how that execution unit/storage element can be configured for use in implementing a specific section or pipe in the graph. An example of the hardware units and their corresponding elements is set out below:
Weight Fetch (WF): NEDWeightFetchElement
Input Reader (IR): NEDInputReaderElement
Output Writer (OW): NEDOutputWriterElement
Convolution Engine (CE): NEDConvolutionEngineElement
Transform Unit (TU): NEDTransformUnitElement
Vector Engine (VE): NEDVectorEngineElement

The NED therefore may specify the execution unit or in other words specify a compatible execution unit for each operation. In embodiments there may be more than one execution unit of a given type such as InputReader may have two command queues which can operate concurrently. A NED may specify which of the queues is assigned so that there remains a 1:1 relationship between what the NED specifies and the physical hardware to which it points.

The dataflow and dependencies of the task's graph is described by pipes, which are described in another element as part of the NED: NEDPipeElement. Pipes are used to represent data storage elements within the neural engine 700 and describe the relationship between sections (operations) in a producer-consumer relationship: the output destination pipe (e.g. a pipe number) and each input source pipe (e.g. a pipe number) for every section is defined in the NED elements of the NED. A pipe has only a single producer but may have multiple consumers. A pipe may be mapped to one of several different locations (e.g. storage elements in the neural engine 700), but not all locations may be suitable for the different section operations. It will be appreciated that, in some arrangements, a pipe may be mapped to only a portion of a storage element—e.g. a number of physical buffers, allowing it to describe double-buffering (for example) behavior between its producer and consumers. The output data generated by a section and stored in a pipe is referred to equivalently as both a block (of data) and a (virtual) buffer, with a block of data occupying one physical buffer location. Irrespective of location, pipes may be non-coherent with a wider memory system associated with the neural engine 700 and with processor 630, and data is stored out using the Output Writer element of the neural engine 700.

In some arrangements the NED may be configured such that the same pipe is used for multiple inputs, where any relevant usage constraints (such as format or location) are satisfied. For example, an element-wise multiply might have the same pipe for the two input operands in order to square the input.

In some embodiments, sections such as InputReader and WeightFetcher have no pipes and instead their data comes from external memory, such as an external cache or DRAM. By contrast, some sections, such as OutputWriter have no output pipes. In this case, their data is written to external memory.

For a section to run, it must have all the appropriate buffers available for its input source pipes. A section may produce a new buffer in its output destination pipe and so there must be space available in the pipe for this new buffer. In the case of a reduction operation (convolution, for example), a section may repeatedly read back and update the previous buffer it generated. As a result, for a reduction operation there is a distinction between the reduction operation having first generated the output buffer and the reduction having completed and the output buffer being fully available, due to this update process. Put another way, there is a point in time at which the output buffer exists in the input pipe of a subsequent operation, but it is not yet ready to be consumed by the subsequent operation. The neural engine 700 is responsible for tracking all of these dependencies, in which buffers are tracked like FIFO entries, but with buffers only available for consumers when a producer has completed any sequence of reductions, and with buffers only freed up when all consumers have completed operations dependent on them.

A task's graph has a directed dataflow. A reduction operation will both read from and write to their output destination pipe's buffer. For example, the convolution engine may repeatedly accumulate into the same accumulator buffer.

In this example implementation, the neural engine is stateless between tasks: all control state is encapsulated in the task's NED, and all data is encapsulated in the pipes defined by the NED. There is no sharing of pipes between tasks and therefore no architected sharing of data between tasks within the neural engine 700. Data reuse and sharing is achieved only through memory by use of the Output Writer in a preceding task and the Input Reader in a later task. The neural engine will cache memory descriptors, including the NED, between tasks; this cache is invalidated each time a complete neural workload is completed (e.g. the total neural network and not just the sub-graph associated with a specific task). However, it will be appreciated that this is just an example implementation.

The NED is split into multiple data structures that may appear contiguously in memory to be read by the neural engine 700. In this example implementation, the NED header defines the dimensions of the operation space of the operations to be performed. Specifically, the NED header defines the total size of the NED (e.g. number of bytes to used to represent the NED) as well as a count of the number of section and pipes that are present in the graph.

For each section and pipe in the graph, a count of a corresponding mapped sub-descriptor element types is represented in the NED header. For instance, where the graph (or sub-graph) contains a number of sections, each of those sections is to be executed on a particular compatible execution unit of the neural engine 700. For each section, an element of the appropriate type is therefore counted in the NED header to represent the hardware requirements needed to invoke execution of the graph. For example, for a section that defines a convolution operation, a corresponding configuration and invocation of a convolution engine execution unit would be required. Similar counts of instantiations of weight fetch and input read execution units is counted based on the presence of sections that use those operations. This is reflected in the count in the NED header against the weight fetch and input reader elements associated with the weight fetch and input reader units in the neural engine 700.

The NED also contains information that describes any divergent or convergent branches between sections and pipes. For example the NED identifies, for each pipe in the graph, the number of producers and consumers associated with that pipe.

The NED header therefore essentially identifies the operation space and a count of all instances of sections and pipes (for each type of hardware element that is to be allocated for instantiating a section or a pipe that will be required to execute the graph (or sub-graph)) defined by the NED. In addition to the NED header, the NED further comprises sub-descriptor elements (defining either the configuration of an execution unit or storage element to operate as a section or pipe) for each instance of a section and/or pipe. Each sub-descriptor element defines the configuration of the associated hardware element (either execution unit or storage element) required to execute the section and/or pipe.

The theoretical minimum and maximum operation space dimension sizes may be defined at compilation based on the configuration of the neural engine, specifically such that the operations of the task (e.g. sub-graph) can be performed without requiring intermediate data to be stored in a memory element outside of the neural engine.

The NED header may also comprise pointers to each of the sub-descriptor elements to enable the specific configuration of each element to be read by the handling unit 720.

As mentioned, each instance of the sub-descriptor element defines a configuration of the hardware element (e.g. execution unit or storage element) to which it relates. The following description will provide an example sub-descriptor for a convolution engine.

In an example, the convolution engine is an execution unit which is configured, when invoked, to perform a convolution or pooling operation selected from one or more convolution operations for which the convolution engine is configured. One such example is a 2D convolution operation as described above. In the example of the 2D convolution operation described above, the operation space is 7D—namely [oc, n, oy, ox, ic, ky, kx].

TABLE 1

Field
Stride X and Stride Y
Dilation X and Dilation Y
Operation type (e.g. which type of
convolution operation is to be
performed)
Input width and height
Pad Left
Pad Top
Source 0 pipe (input feature map pipe)
Source 1 pipe (weight pipe)
Destination pipe

In this example, the operation type may for example take the form of one of pooling (average or max pooling), 2D convolution, or 2D depth-wise convolution. The source 0 pipe field might identify from which pipe the convolution engine should read the input feature map data—this may for example be a specific portion of a shared buffer. Similarly the source 1 pipe field might indicate from which (different) portion of the shared buffer the weight data is to be retrieved. Finally, the destination pipe might indicate that an accumulation buffer is to act as the pipe for the output of the operation performed by the convolution engine. By identifying for a section specific source and/or destination pipes, which have unique identifiers in the task definition (the NED), any preceding or subsequent sections are implicitly connected and sequenced. Another sub-descriptor element referencing the destination pipe of a different section as a source pipe will inherently read that data and the buffer allocation for that destination pipe may only be released once all of the dependencies have been resolved (e.g. that the sections that rely on that portion of the accumulation buffer have all completed reading that data).

Similar sub-descriptor elements exist for all sections based on configuring the execution units to perform operations. For example, sub-descriptor elements may define destination and source pipes, a pointer to a transform from operation to section space, and a mode of operation for the section.

In this example implementation, pipes represent all storage within the neural engine: all allocation and memory management is handled through a task's NED Pipe definitions and the traversal through the sections that produce and consume these pipes. There is no sharing of pipes between tasks and therefore no architected sharing of data between tasks within the neural engine. A sub-descriptor element is defined in the NED for each pipe in the graph.

### Neural Engine Dimensions and Iteration

A neural engine task describes a 12D bounding box (operation space) of which a 6D subset of dimensions is operated on by the memory management sections (DMA 728, input reader 724 and output writer 726). The operations to be performed are defined by a NED that the task provides a pointer to. The command processing unit 640 may issue different tasks to different neural engines. The NED additionally defines an increment size for each of these 12 dimensions to be stepped through, known as a block size. Execution of the graph against this 12D operation-space can be considered as a series of nested loops.

The NED splits the execution of the task's operation-space into a series of blocks, with sections being invoked on a block-by-block basis, operating on a block's worth of data in every source and destination pipe. Consequently, defining a general operation space in a coordinate system having for example twelve dimensions may provide a low complexity pattern for execution of any task comprising operations on data, instead of relying on fixed functions per task type, which may encompass a significant risk of missing necessary combinations of patterns. By defining a common operation space in a coordinate space, it may be less complex to link a plurality of operations to be executed on data to each other and coordinate execution of these functions. Operation space dimensions does not have a specific interpretation until they are projected into space for a specific task.

The number of dimensions in use is dependent on the graph and its operations; not every section will run for increments in each dimension. For example, a convolution operation has a 7D operation-space but only a 4D output space through which the convolution operation increments and accumulates output; a VE scaling operation following a convolution thus only runs for increments in the first four dimensions. This relationship is described by two variables, the number of operation-space dimensions triggering increments for each section, dims_inc_run (a “dimensions increment run” value), and the number of operation-space dimensions generating new blocks for each pipe, “dims_inc_buf” (a “dimensions increment buffer” value), both of which are encoded in their respective NED elements. Both fields are specified counting dimensions from the outer-most dimension #0 up to the inner-most dimension #11.

dims_inc_run specifies how many operation-space dimensions trigger invocations of the section when those dimensions increment in operation-space. Example usage of dims_inc_run is illustrated below:
0: the section is independent of the operation-space and will therefore only be invoked once for the task;
1: the section may depend on operation-space dimension #0, and is invoked for each operation-space step through dimension #0; and
11: the section may depend on all operation-space dimensions, and is invoked for each operation-space step.

dims_inc_buf specifies how many operation-space dimensions generate a new block in the pipe when those dimensions increment in the producer section, effectively defining how many blocks the pipe generates throughout the duration of the task.

If the value of dims_inc_buf is k (where k>0), then pipe.blocks=dim [0].blocks*dim [1].blocks* . . . *dim [k−1].blocks whereas if the value of dims_inc_buf is k (where k==0), then the pipe only ever has a single block.

For simple operations, dims_inc_run will be equal to dims_inc_buf for all source input and output destination pipes, but for more complex operations, dims_inc_run may be greater.

Where dims_inc_run>dims_inc_buf for a source pipe: this relationship between the fields indicates the reuse of a buffer through one or more operation-space dimensions, the difference between the two values specifying the number of reuse dimensions. In this context, reuse means that the data is broadcast through the extra dimensions i.e. the buffer in the Neural Engine's internal memory is consumed multiple times. For example, the feature map input to a convolution operation is typically reused against the weight kernel x and y dimensions of the convolution engine.

Meanwhile, for a destination pipe, dims_inc_run>dims_inc_buf indicates the reduction of one or more operation-space dimensions' set of buffers, the difference between the two values specifying the number of reduction dimensions. In this context, reduction means that the data from the extra inner operation-space dimensions are accumulated in the smaller number of outer operation-space dimensions (with the section reading back and updating its output buffer over multiple invocations). For example, a vector block reduction operation will result in a smaller number of buffer increments.

Where a pipe has multiple consumers, there is no relationship between those consumers and no restriction or requirement on the value of dims_inc_run for a consumer with respect to other consumers.

In the examples described herein, the neural engine's handling unit is responsible for iterating through this 12D operation-space for each section described in the NED graph. The handling unit uses the two values, dims_inc_run and dims_inc_buf, to determine which increments are relevant and to correctly manage the dependencies between the sections and their pipes. Each section operates in its own local coordinate space, known as the section-space, and the handling is responsible for transforming each relevant operation-space block (relevant through an increment in a run dimension) into this section-space. In the examples described herein, this transformation may be programmatic and described with a small program in a specialized (or general purpose) ISA that is executed for each block before the section is invoked.

The handling unit may be synchronizing the execution of multiple different parts of these nested for-loops in parallel, and therefore needs to track where in the loop a function of a component should be invoked, and where in the loop, data that may be needed by subsequent components (based on the partially ordered set of data structures) is produced. To achieve this in a flexible way, which still allows for a straightforward hardware implementation, two types of dimensions are specified in each data structure.

In some embodiments, each data structure comprises N vectors of binary values indicating, for each of the N dimensions of the coordinates space, whether changes of coordinate in said dimensions while executing the task causes the function of the associated component to execute or not and causes the function of the associated component to store data in the storage or not (DIMS_INC_RUN). Effectively, this allows for the behavior of each component for each dimension to be encoded as a multi-hot vector of behaviors. Behaviors may include for example reuse, recompute, reduce, output, unmapped/once.

The data structure described may be generated by e.g., a compiler connected to the processor, wherein the complier is configured to generate code for the processor to execute. The execution of a neural engine task may be defined by two separate iterative processes implemented in the handling unit. In one process, the handling unit iteratively steps through the task's operation-space in block units as defined by the block size of the NED. In the other process, the handling unit iteratively steps through the dataflow graph defined by the NED and, where permitted by the dimension rules described above, transforms each block into the relevant section-space before invoking the section's execution unit with the transformed block by issuing invocation data.

In general, for most cases, these two processes are defined in the examples described herein to be architecturally independent. This means that the execution of any given block is defined definitively and completely in itself, in isolation of any other block or the state of the handling unit operation-space iteration. The execution of blocks that are not in accordance with this operation-space iteration and transformation will run to completion, but the output will not provide meaningful results with respect to the full operation definitions of the Tensor Operator Set Architecture.

In all cases, execution of a block must not extend beyond the block's section-space boundaries. Loading and storing of data (whether mapping the section-space to coordinates of a tensor in memory, to pipes, or any other memory or pipe storage) may extend beyond the section-space as required by an implementation's granularity of access but must not extend beyond the size of a pipe's buffer or the total size of a tensor.

When the handling unit 720 invokes an execution unit to execute a block, the handling unit 720 is configured to issue invocation data to execute the operation on a block. The block iteration is defined based on a block size specified in the NED and the issuance of the invocation data is done under the control of the DIMS_INC_RUN value as discussed above. Moreover, it is necessary for any dependencies that need to be met for the execution unit to operate on the block. These include that the required data is stored in the source pipe(s) for the operation and that sufficient storage is available in the destination pipe, as well as that the transform of the operation space to section space for that section has been performed and the output of that transform operation (i.e. the transformed coordinate data) is available to be issued to the execution unit. More specifically, it is to be ensured that there is sufficient availability in the pipe for a new block or buffer. Determining the availability of a source storage element may involve determining there is an appropriate block/buffer in the source pipe.

In an example, the invocation data comprises the output of the transform program in the form of transformed coordinates along with the relevant parts of the NED that describe that section (e.g. the configuration data from the sub-descriptor element of the NED for that section). This additional configuration data may also include the type of operation being performed (where the execution unit is able to perform more than one type of operation) and any other attributes of the operation, such as stride and dilation values in the example of a convolution operation.

The iteration process first involves reading from the NED a block size and iterating through the operation space one block at a time. For each block, a transform program is executed to transform the operation space coordinates to section space coordinates for that section. More detail on the transform programs is set out below. Once the section space coordinates have been determined, the section operation is performed in respect of that block. This process is iterated over all blocks until the operation is completed for all blocks.

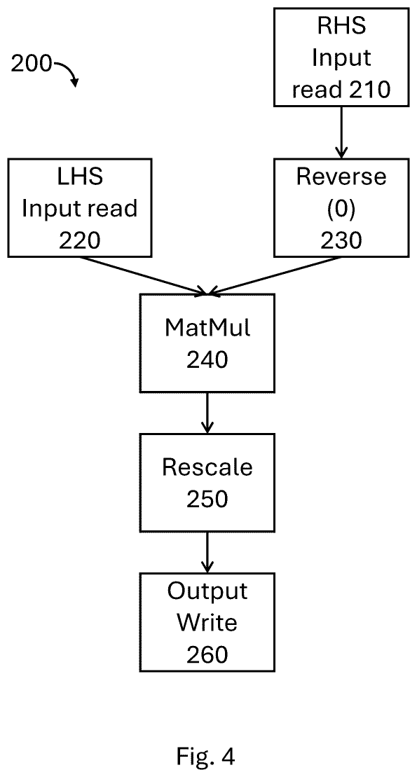

FIG. 4 illustrates an example progression 200 of operations to be performed. The progression comprises a left-hand-side (LHS) input read operation 220 and a right-hand-side (RHS) input read operation 210. The output of the RHS input read operation 210 is input into a Reverse operation 230 which in turn is output, along with the output of the LHS Input Read operation 220 into a Matrix Multiplication (MatMul) operation 240. The output of the MatMul 240 operation is input into a Rescale operation 250, the output if which is provided to an Output Write operation 260 that writes the output to memory.

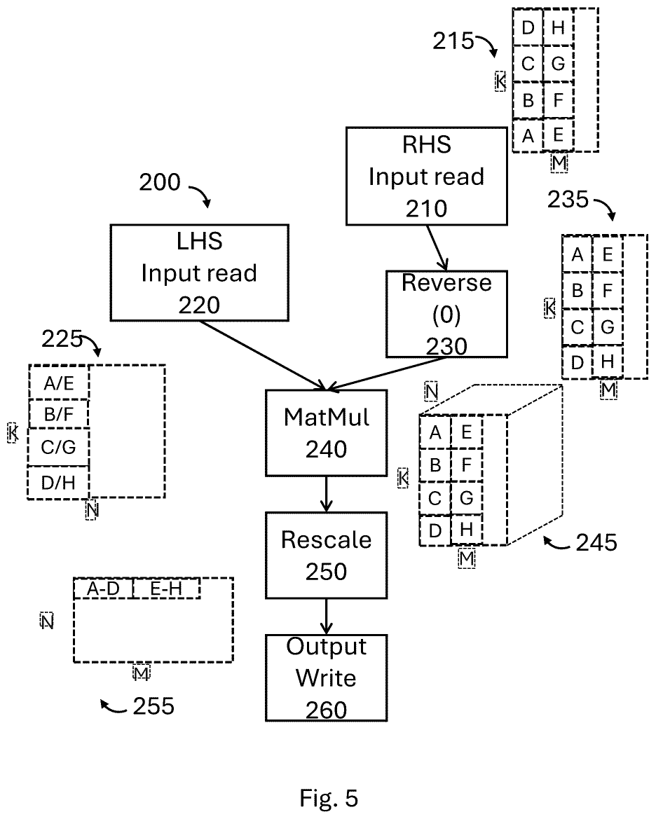

FIG. 5 illustrates the corresponding coordinate space (i.e. the section space for each of the operations). For example, the RHS Input Read section space 215 is illustrated for the RHS Input Read 210 operation. The LHS Input Read section space 225 is illustrated for the LHS Input Read operation 220. The Reverse section space 235 is illustrated for the Reverse operation 230. The MatMul section space 245 is illustrated for the MatMul operation 240. The Rescale section space 255 is illustrated for the Rescale operation 250. In this example, the section space for the Output Write operation is illustrated using the section space 255 since this is unchanged from the section space for the Rescale operation.

Each section space comprises a plurality of dimensions—namely two dimensions (e.g. K,N; K,M). The section space is separated into blocks having a pre-defined block size—with each of blocks A to H representing a different block to be operated on in line with the examples set out herein.

As can be seen, the Reverse section space 230 has a dimensionality which is effectively reversed with respect to the RHS Input Read section space 215. Section space 225 for the LHS Input Read contains blocks A/E, B/F, C/G, D/H which are repeated. The section space 255 for the Rescale and Output Write operation contains two blocks, A-D and E-H. This is because the MatMul operation is a reduction operation. In the MatMul example in FIG. 5, a MatMul of two matrices 225 with 235 is performed. Matrix 225 has dimensions K×N and matrix 235 has dimensions K×M. The output 255 has dimensions N×M, so the K dimension has been reduced. MatMul could be described with the 3D operation space of N, M, K.

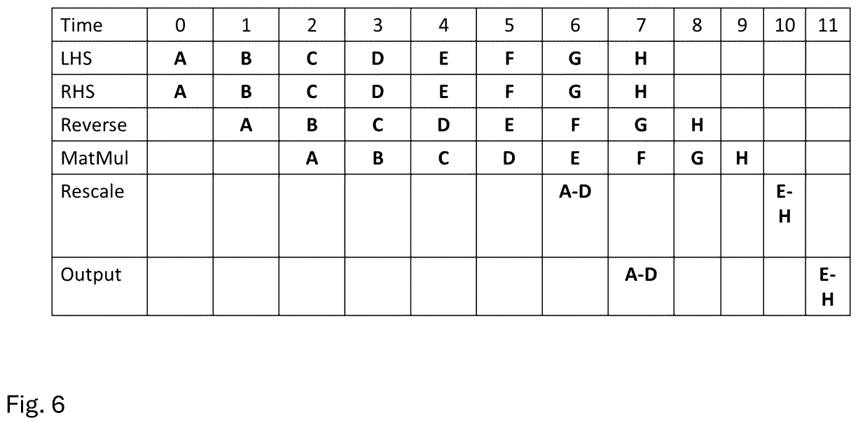

As will be appreciated the operations set out in FIG. 5 are sections which can be respectively executed by different execution units. The handling unit may be configured to control execution of the various blocks such that a particular block is able to flow through the progression of operations defined by the graph or sub-graph. The “A/E” notation in these figures illustrates that a block is being repeated. For example, blocks A and E have the same coordinates in some dimensions (K, N) but there is another dimension (M) that has changed but is not mapped into 220's coordinate space. The “A-D” notation indicates that blocks have been reduced and merged into a single block. E.g. blocks A, B, C, D have been reduced down into a single block. These blocks vary in dimension K but dimension K has been reduced. An example scheduling of the blocks set out in FIG. 5 is illustrated in FIG. 6.

FIG. 6 illustrates an example iteration through blocks for the progression of operations in FIGS. 4 and 5 for a series of invocation time instances 0 to 11. At invocation time instance 0, block A is processed concurrently by execution units executing LHS and RHS read operations. These operations have no dependencies and in this example can be handled in a single invocation time instance and so are issued concurrently. Since LHS and RHS read operations are not dependent on one another, for all subsequent invocation time instances a next block (e.g. block B at time instance 1) is invoked for execution until all blocks A to H have been executed at time instance 7. This operation may still stall if there is not space in the destination pipe for that section.

Since the Reverse operation is a subsequent operation dependent on the output of the RHS read operation, the processing of block B by the Reverse operation can only be invoked at time instance 1. The processing of blocks by the Reverse operation is therefore delayed by one invocation time instance with respect to the RHS read operation. Similarly, the MatMul operation is dependent upon the output of the Reverse operation and so the MatMul processing of blocks is further delayed by one invocation time with respect to the Reverse operation.

Rescale operation operates on block of data which is derived from a set of four reduced blocks of data, e.g. A to D or E to H in a single invocation. As such, the Rescale operation is not invoked until all input dependencies have been met, i.e. that the MatMul operation has been performed on each of blocks A to D at time instance 6. Similarly, blocks E to H are not invoked for execution until time instance 10. The Output Write operation is dependent upon the completion of the Rescale operation and so is not invoked until time instance 7 for a block derived from the processing of blocks A to D, and similarly at time instance 11 for a block derived from the processing of blocks E to H.

In this way, the processing iterates through all the blocks until the complete operation space has been executed.

The process for generating an operation space from which each of these respective section spaces can be expressed will be described in more detail later but in this example the operation space for this progression of operations is taken to be the section space 245 for the MatMul operation 240 since all other section spaces can be expressed from the MatMul section space 245.

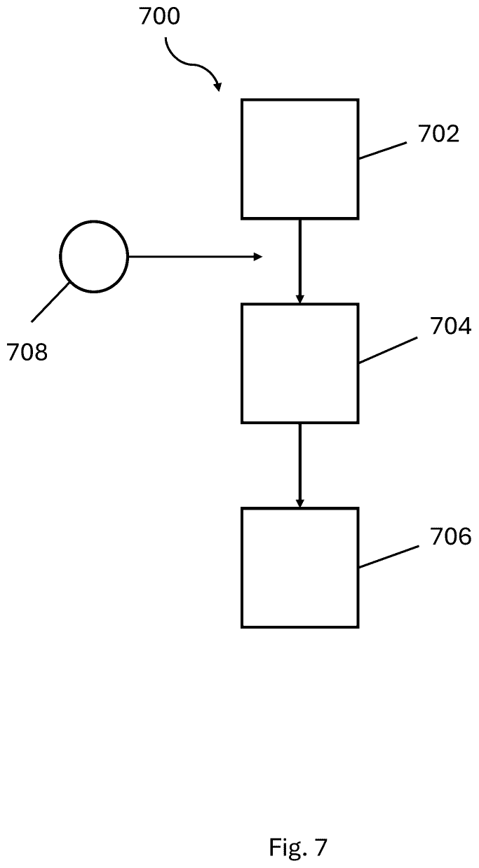

FIG. 7 illustrates a flow-chart of a data processing method 700. The data processing method 700 is carried out on a processor configured for handling task data and comprising a handling unit, a plurality of storage elements, and a plurality of execution units. The task data includes a program comprising transform program data that describes a transform from operation space to section space (local space) for a corresponding section. At step 702, the processor obtains from storage the task data in the form of a directed graph of operations. Each of the operations maps to a corresponding execution unit of the processor and each connection between operations in the directed graph maps to a corresponding storage element of the processor. At step 704, for each corresponding portion of the operation space, the method 700 includes transforming the portion of the operation space to generate respective operation specific local spaces for each of the plurality of the operations of the directed graph. At step 706, the method 700 includes dispatching to each of a plurality of the execution units associated with operations for which transformed local spaces have been generated, invocation data describing the operation-specific local space, and at least one of a source storage element and a destination storage element corresponding to a connection between the particular operation that the execution unit is to execute and a further adjacent operation in the directed graph to which the particular operation is connected. The processor is further configured, where necessary, to perform clipping 908 on lower and upper bounds of a task and operation space before running the transform.

### Memory Management

As mentioned above, a neural engine task describes a 12D bounding box of which a 6D subset of dimensions is operated on by the memory management sections (DMA 728, input reader 724 and output writer 726). The operations to be performed are defined by a NED that the task provides a pointer to. More specifically, a command, Run Neural, is sent from the command processing unit 640 to the neural engine 700. A further Resource message is sent from the command processing unit 640 to the neural engine 700. These messages are stored as structures locally on the neural engine 700. The Run Neural command/structure includes a pointer to NED for the operations to be performed. The Resources message/structure includes a neural resource table and pointers that includes an array of tensor descriptors that describe tensors for use by the neural engine 700.

The tensor descriptors are loaded into the internal cache of the neural engine and are accessible by the handling unit 720 while the task is performed. The NED that is pointed to by the Run Neural command is loaded and parsed by the handling unit 720. The NED contains input reader and output writer elements, as described above, that contain configuration information destined for input reader 724 and output writer 726 hardware that respectively read data into and write data from a local storage in the form of the shared storage 738. Accordingly, the handling unit 720 generates and sends invocation data to the input reader 724 and output writer 726 and other internal components of the neural engine 700 to control iteration through blocks of tensor elements that are referred to in the Resources message/structure and cause the neural engine 700 to perform the task indicated by the Run Neural command.

In practice, a task defined by the NED quite often requires four or fewer dimensional data from tensors identified by the tensor descriptors. Accordingly, in some implementations, it may be desirable that the neural engine 700 is configured to work with four-dimensional data.

As described above, the input reader 724 is configured to read data to be processed by the neural engine 700 from external storage (such as L1, L2 cache or other hierarchical memory), such as a block of data representing part of a tensor. The output writer 726 is configured to write data obtained after processing by the neural engine 700 in the shared storage 738 to the external storage. The input reader 724 and output writer 726 interface with the external storage (which is for example the local cache 656a, 656b, which may be a L1 cache such as a load/store cache) via the DMA unit 728. The data read by the input reader 724 may be stored in the shared storage 738. As described above, other internal components (such as vector engine 732, transform unit 734, DPU array 730, etc.) of the neural engine 700 may perform operations on the data values stored in the shared storage 738 before the output writer 726 reads data from the shared storage 738 and stores it in the external storage.

As mentioned above, each 6-dimensional tensor of data (tensor elements) stored in the external storage is stored with a tensor descriptor. The tensor descriptor includes pointers to storage segments (locations where tensor data is stored), for example up to three storage segments. One segment may contain primary data in the form of tensor element values. The other two segments are optional and may store auxiliary data in the form of scale factors for use with block-scaled formats and an optional segment for mask data for use with structured sparsity. As explained further below, in other embodiments other data may be stored as auxiliary data.

The scale factor may be a scale by which a tensor element value in a block should be multiplied to recover the tensor data value. For example, if the tensor element values are floating point values, the scale factor may be a multiplier (power of 2 exponent) applied to each tensor element value in a brick of tensor elements.

Structured sparsity may be used to compress sparse tensor data (that contains many zero values) and allows the tensor element values in the first segment to correspond to a subset of the actual tensor element values, with the location of the tensor element values indicated by mask data. Generation of tensor data with structured sparsity is known in the art and is, for example, supported by Pytorch®.

The mask data (bit mask) may indicate tensor element values that are used/not-used. In 2:4 sparsity, the mask bits allow exactly 50% of tensor elements to be removed. The mask bits in the sparsity plane indicate which values (of the 50%) are stored as tensor elements in the value plane. Sparsity is an optional setting and is used with data that is already sparse in nature. In one implementation, zeroed values in the sparsity mask data aren't stored in the value plane.

In an example of 2:4 sparsity, 4 bits of mask data are provided for each two tensor element values in the value plane. With no sparsity, the number of tensor element values (if using 8-bit value date) would be 4*8 bits=32 bits. By introducing sparsity, including a 4-bit mask and two 8-bit values, the total number of bits is 4+2*8=20 bits.

The tensor descriptor specifies whether the tensor elements are arranged as linear-strided data or as bricks of tensor elements. Linear-strided layouts have the tensor elements laid out sequentially in memory. Brick layouts have the tensor elements laid out in interleaved units of memory referred to as bricks. The shape of the bricks varies depending on the value size of the tensor elements (e.g. FP32, FP16 etc. when using floating point) as well as the segment they are located in (for example mask data in the sparsity plane).

The tensor elements are accessible in addressable units of memory that depend on the layout of the tensor elements and a size of the tensor elements. These units are used as a basis for the strides that describe how the tensor dimensions are laid out in memory. For example, an address in memory may be determined by multiplying a position in the tensor in each dimension by a corresponding stride in that dimension and adding that value to a base address. The tensor elements in the innermost dimension are tightly packed. The remaining dimensions may either be tightly or loosely packed depending on the stride configuration.

In the example being described, the Tensor descriptor describes tensors in six dimensions. In other implementations, different numbers of dimensions may be used.

When storing data that has fewer than six dimensions, only the innermost dimensions are used:
a 1D tensor uses only dimension #5
a 2D tensor uses dimensions #4 and #5
a 3D tensor uses dimensions #3, #4, and #5
a 4D tensor uses dimensions #2, #3, #4, and #5
a 5D tensor uses dimensions #1, #2, #3, #4 and #5
a 6D tensor uses all six dimensions #0-5

The input reader 724 and output writer 726 need to be able to calculate addresses to access different tensor positions. As noted above, strides for different dimensions that indicates how the dimensions of the 6-dimensional tensor are stored in the external memory are stored in the tensor descriptor. The DMA 728 may determine a storage address based on a base address and by multiplying the coordinates of a position within the tensor by a stride associated with the dimension of each coordinate in order to obtain the storage address. As noted above, the stride may also be multiplied by a unit size that depends on the type of data being stored in the tensor.

The tensor may include tensor element values, scale values and mask data. As the tensor element values, scale values, and masks data may be stored in different storage segments, it might be necessary to store three different sets of stride information to allow the DMA to identify addresses for each of the tensor element values, scale values, and mask data. As noted above, the tensor descriptors are loaded into the internal cache of the neural engine 700 during use. Accordingly, it is desirable to keep the size of the tensor descriptor as compact as possible. In some implementations, therefore, the positions of the scale values and mask data are determined using a virtual stride that is derived from the stride values for the tensor element values for each dimension.

In a case that the virtual stride values for auxiliary data are derived from the stride value in the tensor descriptor, it has been realized that, in a case where a brick format is used, it is desirable that bricks of tensor element values, scale factors and mask data align in some easy to determine manner. In this way, calculations that need to be performed by the DMA 728 to calculate the addresses can be keep simple. A method for determining virtual strides from strides included in a tensor descriptor will now be described. It will be apparent that the stride/virtual stride determination scheme controls address generation by the DMA 728 and hence determines how the data is stored in and retrieved from a storage such as an external storage.

The tensor element values are stored in a value segment of the tensor (also referred to as the ‘value plane’). The tensor descriptor includes a ‘value pointer’ that provides an address of the start of the value segment of the tensor. Similarly, scale values are stored in a scale segment of the tensor (also referred to as the ‘scale plane’). The tensor descriptor includes a ‘scale pointer’ that provides an address of the start of the scale segment of the tensor. Sparsity data is stored in a sparsity segment of the tensor (also referred to as the ‘sparsity plane’). The tensor descriptor includes a ‘sparsity pointer’ that provides an address of the start of the sparsity segment of the tensor.

When accessing values from the tensor, it is often preferable to access the tensor elements in bricks. Alternatively, a linear access mode can access tensor elements individually. A brick of data may span multiple dimensions of the tensor. In some examples, these bricks are 2d rectangles that correspond to the size of (or a multiple of the size of) a cache line used by processing elements within the neural engine. It is noted that when accessing a tensor using bricks, if the tensor is not an integer multiple of the brick size, then partial bricks of tensor elements may be read at the end of one or more dimension in a case that a full brick of elements is not available in that dimension. The brick of elements may be padded to provide a complete brick of elements to be written to the shared buffer 738.

In a case of accessing bricks of tensor elements in the value segment, it becomes desirable to access bricks of scale values and sparsity mask data in the scale and value planes as well so that values to be processed can be recovered. Accordingly, each plane has their own brick sizes and the bricks may be selected to align between the planes. As described further below, there may not be a 1-to-1 relationship between bricks in the value, scale and sparsity planes.

Table 2 below shows an example of a set of brick sizes for bricks of tensor elements in the value plane. The table shows the size of the brick in each dimension. For example, Brick_1×1×8×1 picks 8 values in a line in dimension #2. Similarly, Brick_1×1×8×8 picks 64 values in a 2d rectangle in dimensions #2 and #3. Please note that there are 6 dimensions of the tensor. However, the size in the brick in the outer two dimensions is always one. Accordingly, a brick size 1×1×8×8 could be referred to as having dimensions 1×1×1×1×8×8 etc.

TABLE 2

| | | No. | No. | No. | No. |
|---|---|---|---|---|---|
| | | values. | values | values | values |
| Value | Name | #2 | #3 | #4 | #5 |
| 0 | Brick_1 × 1 × 8 × 1 | 1 | 1 | 8 | 1 |
| 1 | Brick_1 × 1 × 8 × 2 | 1 | 1 | 8 | 2 |
| 2 | Brick_1 × 1 × 8 × 4 | 1 | 1 | 8 | 4 |
| 3 | Brick_1 × 1 × 8 × 8 | 1 | 1 | 8 | 8 |
| 4 | Brick_1 × 1 × 8 × 16 | 1 | 1 | 8 | 16 |

The brick sizes in the value plane are selected in accordance with the width of the values being stored (value_size_bits). If the width of the values being stored is 4-bits then the brick format is 1×1×8×16, if the width of the values being stored is 8 bits, then the brick format is 1×1×8×8, if the width of the values being stored is 16 bits then the brick format is 1×1×8×4, if the width of the values being stored is 32 bits then the brick format is 1×1×8×2 and if the width of the values being stored is 64 then the brick format is 1×1×8×1. This serves to keep the size (in bits) of the bricks being fetched the same size. In some implementations, the size corresponds to the size of a cache line of the neural engine 700 (in this example 512 bits).

Table 3 below shows brick sizes for the scale value plane. Here is should be noted that one scale value is shared between 32 tensor element values in the value plane. That is to say that the same scale value will be applied to each of the 32 tensor element values in order to recover the stored data value. Both bricks have a size of 64 scale values (32×2 or 8×8). Accordingly, one scale brick will contain enough scale values for 2,048 tensor element values in the value plane.

TABLE 3

| | | No. | No. | No. | No. |
|---|---|---|---|---|---|
| | | scale | scale | scale | scale |
| Value | Name | F. #2 | F. #3 | F. #4 | F. #5 |
| 0 | Brick_1 × 1 × 32 × 2 | 1 | 1 | 32 | 2 |
| 1 | Brick_1 × 8 × 8 × 1 | 1 | 8 | 8 | 1 |

Table 4 shows the single brick size that is used for picking bricks of sparsity plane values. The sparsity values in this example implement 2:4 sparsity. Accordingly, there are two values in the value plane for each four elements of the mask data. The mask data may be binary and may indicate the positions occupied by the tensor element values in the value plane. The size of the sparsity brick is 512 sparsity mask bits.

TABLE 4

| | | No. | No. | No. | No. |
|---|---|---|---|---|---|
| | | sparsity | sparsity | sparsity | sparsity |
| Value | Name | MB. #2 | MB. #3 | MB. #4 | MB. #5 |
| 0 | Brick_1 × 1 × 32 × 16 | 1 | 1 | 32 | 16 |

The brick sizes may be selected to have a largest size in each dimension of: one in dimensions #0/#1/#2, eight values in dimension #3, thirty-two values in dimension #4, and sixty-four values in dimension #5. As will be described further below, the brick sizes may be selected so that a common multiple can be identified for calculating virtual strides to determine the positions of the bricks within the tensor. It is noted that the shapes of the bricks may be different in different planes.

The brick sizes may be selected so that the virtual stride to move between bricks in the scale plane and the sparsity plane are a multiple of two compared to the stride in the value plane. By selecting the strides and brick sizes in this way, the DMA 728 may determine the virtual strides from the stride in different planes by performing a bit-shifting operation. The addresses may then be determined for loading scale and sparsity bricks starting from the relevant base address in the tensor descriptor as described above.

The stride in each dimension matches or exceeds the size of the data in the next inner dimension. The reason for this is to allow the data of the next inner dimension associated with a coordinate value to be stored before incrementing to data associated with the next coordinate value. The innermost dimension of the 6 dimensions (i.e. dimension #5) is aligned according to the smallest addressable unit as defined by the data format and layout as discussed above (which may be referred to as ‘tightly packed’).

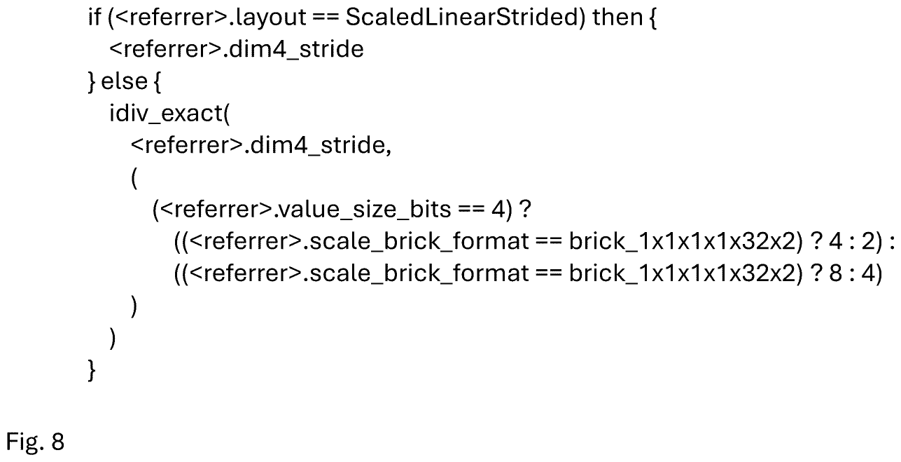

An example of determining a virtual stride will now be given. The dimension #4 virtual stride in the scale plane may be determined by the pseudocode shown in FIG. 8. The first two lines indicate that if the tensor descriptor (<referrer>) indicates that the data is stored in a ‘ScaledLinearStrided’ format then the same stride (virtual stride) used for the value plane is used for identifying the location of scale values in the scale plane.

In the next part of the pseudocode, idiv_exact enforces ‘an exact multiple of’ by performing integer division as set out in the following code.

The line ‘(<referrer>.value_size_bits==4)? asks whether the size of the units (value_size_bits) is equal to 4. In a case where the size of the units is equal to 4, the question is asked whether the scale brick format is 1×1×1×1×32×2-if yes, the divisor should be 4, if not (i.e. the format is Brick_1×8×8×1) then the divisor should be 2.

If the unit size is not equal to 4 (in one example value_size_bits may take values of 4, 8, 16, 32 or 64 bits), then if the scale brick format is 1×1×1×1×32×2, then the divisor should be 8 and if not, the divisor should be 4.

The divisors above can be understood intuitively. It is recalled that each scale value corresponds to 32 tensor elements in the value plane. Accordingly, the brick format 1×1×1×1×32×2 has an equivalent size of 1×1×1×1×32×64 in the value plane. As there are 64 values in the inner dimension, corresponding to four bricks of Brick_1×1×8×16 (used for 4-bit width values), the virtual stride in dimension #4 therefore needs to be ¼ of the stride in the value plane for the case where value_size_bits=4.

In the other case, in which the block size is 1×8×8×1, the equivalent size in the value plane is 1×8×8×32. This corresponds to 2 bricks of Brick_1×1×8×16. Accordingly, the virtual stride in dimension #4 therefore needs to be ½ times the stride in the value plane.

In a case that the width of the value is not 4 bits, the brick format 1×1×1×1×32×2 again has an equivalent size of 1×1×1×1×32×64 in the value plane. The brick size in the value plane is 1×1×8×8 depending on the width of the values in the tensor (value_size_bits) as described above. Accordingly, the scale brick corresponds to 8 bricks in the value plane and the virtual stride needs to be ⅛ times the stride in the value plane.

In the other case, in which the block size is 1×8×8×1, the equivalent size in the value plane is 1×8×8×32. This corresponds to 4 bricks of Brick_1×1×8×8. Accordingly, the virtual stride in dimension #4 therefore needs to be ¼ times the stride in the value plane.

Similar calculations are performed to determine virtual strides for each of the other dimensions in the scale plane based on the corresponding stride in the value plane.

An example calculation for dimension 4 in the sparsity plane is as follows:

$$idiv\_exact ( 〈 referrer 〉 . dim4\_stride * 8 , 〈 referrer 〉 . value\_size \_bits )$$

That is to say that the virtual stride in dimension 4 of the sparsity plane is determined by multiplying the dimension 4 stride in the value plane by 8 and then dividing by the width of the values (value_size_bits).

It is recalled that there are four mask bits for every two tensor element values in the value plane. The brick size in the sparsity plane is 1×1×32×16, which is equivalent to 1×1×32×8 in the value plane. Accordingly, for 4-bit width values that use a brick size of 1×1×8×16 in the value plane, there should be two sparsity bricks for each value brick. Accordingly, the virtual stride in the sparsity plane should be twice the stride in the value plane. It is noted that this is the opposite of the situation with the scale bricks where there were more value bricks than scale bricks.

The result above can be reproduced from the example calculation above because 8 divided by 4 gives 2.

Similar logic is made available to determine the virtual stride based on the stride in the value plane for the other dimensions in the sparsity plane.

It is observed that the translation between strides and virtual strides described above was in each case a multiple of two by design of the sizes of the bricks in each of the value plane, scale plane, and sparsity plane. This enables easy determination of the virtual strides by a storage access controller (input reader 724, output writer 726, and DMA 728). For example, the virtual strides may be determined by bit-shifting. Further, because the strides for the scale and sparsity plane do not need to be included in the tensor descriptor valuable storage savings can be achieved.

More particularly, the brick sizes between planes may be selected such that the brick sizes have the same size or are a multiple of two in each dimension after account is taken for the mapping between the numbers of data values in each plane (e.g. 1:32 for scale values and 4:2 for sparsity data).

The examples above refer to value plane, scale plane, and sparsity plane. The value plane forms primary data and the scale plane and sparsity plane are examples of auxiliary data. It is noted that both the scale and the sparsity are ways of compressing the tensor elements stored in the value plane. In other implementations, data for other compression techniques may be stored in addition or in place of the scale and sparsity data as auxiliary data. For example, a fixed-rate data compression technique may be used to maintain an alignment between the amount of auxiliary data and the amount of data in the value plane. For example, in another implementation, predetermined numbers of tensor elements stored in the value plane may be offset by a fixed value. The fixed value may be stored as auxiliary data.

In yet a further implementation, an offset value may be provided as auxiliary data and scale values may also be provided as auxiliary data. A further plane of auxiliary data may be provided as a mask to indicate which of the scale value and offset value apply to each tensor element in the value plane. Many further possibilities for auxiliary data can be considered. The tensor elements provided as auxiliary data may provide information about tensor elements in the value plane.

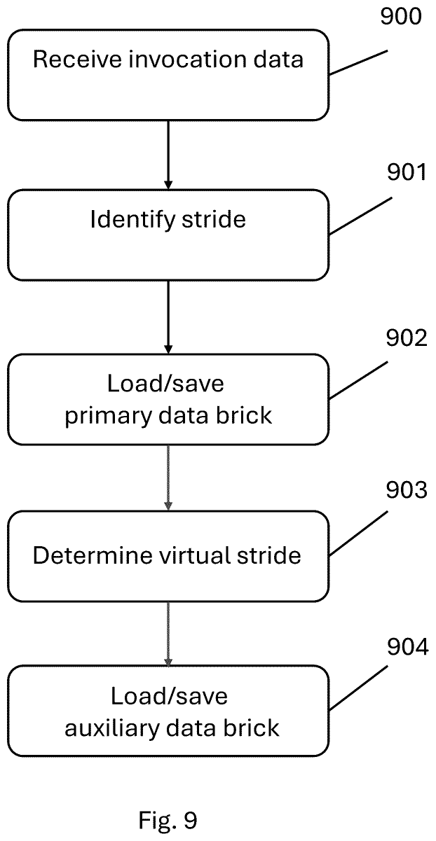

FIG. 9 is a flow chart showing steps performed by a storage access controller (input reader 724, output writer 726, and DMA 728) for identifying an address to load or save data in a tensor. As loading and saving data only differ with respect to the operation performed, both operations will be described together although they will be performed separately in practice. In step 900, the storage access controller receives invocation data from the handling unit 720 to perform a load or write operation from/to a tensor.

In step 901, the storage access controller refers to the tensor descriptor for the tensor and identifies a stride for each dimension of tensor elements stored in a value segment of the tensor. The stride is included in the tensor descriptor.

The storage access controller determines addresses for one or more brick of tensor elements in the value segment by multiplying the coordinates of the data identified in the invocation data by the stride in each dimension and by a unit size and adding the value to an address of the start of the value segment included in the tensor descriptor. In steps 902, the storage access controller loads a brick of tensor element values from or writes a brick of tensor element values to the value segment of the tensor at the determined addresses.

In step 903, the storage access controller determines virtual strides for dimensions of the tensor based on the strides stored in the tensor descriptor. The virtual strides are determined based on logic held by the storage access controller based on brick sizes and/or sizes of the data stored in the tensor.

In steps 904, the storage access controller determines addresses for one or more brick of tensor elements in a segment of the tensor that stores auxiliary data by multiplying the coordinates of the data identified in the invocation data by the determined virtual stride in each dimension and by a unit size and adding the value to an address of the start of the segment of auxiliary data included in the tensor descriptor. The storage access controller loads a brick of tensor element values from or writes a brick of tensor element values to the segment of auxiliary data of the tensor at the determined addresses.

### Other Aspects

At least some aspects of the examples described herein comprise computer processes performed in processing systems or processors. However, in some examples, the disclosure also extends to computer programs, particularly computer programs on or in an apparatus, adapted for putting the disclosure into practice. The program may be in the form of non-transitory source code, object code, a code intermediate source and object code such as in partially compiled form, or in any other non-transitory form suitable for use in the implementation of processes according to the disclosure. The apparatus may be any entity or device capable of carrying the program. For example, the apparatus may comprise a storage medium, such as a solid-state drive (SSD) or other semiconductor-based RAM; a ROM, for example, a CD ROM or a semiconductor ROM; a magnetic recording medium, for example, a floppy disk or hard disk; optical memory devices in general; etc.

Concepts described herein may be embodied in a system comprising at least one packaged chip. In some cases, the processor described earlier may be implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

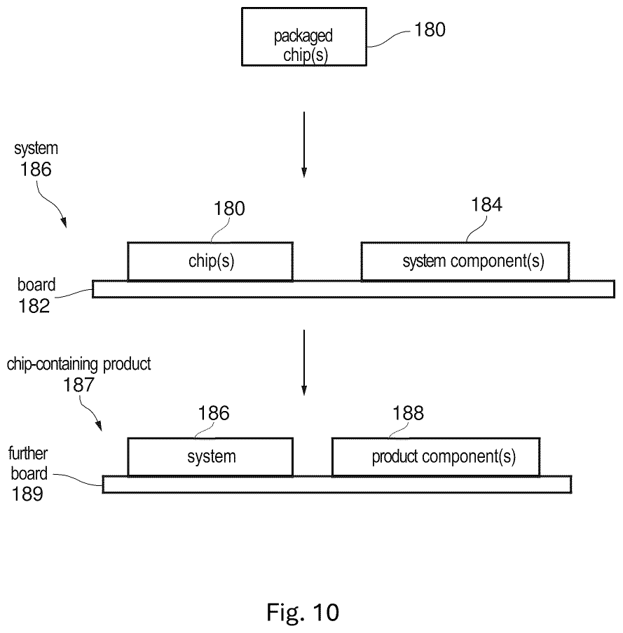

As shown in FIG. 10, one or more packaged chips 180, with the processor described above implemented on one chip or distributed over two or more of the chips, are manufactured by a semiconductor chip manufacturer. In some examples, the chip product 180 made by the semiconductor chip manufacturer may be provided as a semiconductor package which comprises a protective casing (e.g. made of metal, plastic, glass or ceramic) containing the semiconductor devices implementing the processor described above and/or connectors, such as lands, balls or pins, for connecting the semiconductor devices to an external environment. Where more than one chip 180 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 180 are assembled on a board 182 together with at least one system component 184 to provide a system 186. For example, the board may comprise a printed circuit board. The board substrate may be made of any of a variety of materials, e.g. plastic, glass, ceramic, or a flexible substrate material such as paper, plastic or textile material. The at least one system component 184 comprise one or more external components which are not part of the one or more packaged chip(s) 180. For example, the at least one system component 184 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 187 is manufactured comprising the system 186 (including the board 182, the one or more chips 180 and the at least one system component 184) and one or more product components 188. The product components 188 comprise one or more further components which are not part of the system 187. As a non-exhaustive list of examples, the one or more product components 188 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 187 and one or more product components 188 may be assembled on to a further board 189.

The board 182 or the further board 189 may be provided on or within a device housing or other structural support (e.g. a frame or blade) to provide a product which can be handled by a user and/or is intended for operational use by a person or company.

The system 186 or the chip-containing product 187 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Further Embodiments

A first further embodiment provides a processor comprising a neural processing unit. The neural processing unit comprises a handling unit configured to: obtain a description of a task that involves data in a multi-dimensional tensor in a storage, and issue invocation data to a storage access controller to load multi-dimensional bricks from the tensor. The multidimensional bricks comprise a brick of primary data read from a first segment of the tensor and a brick of auxiliary data read from a second segment of the tensor. The storage access controller is configured to: receive the invocation data from the handling unit; identify a location of the brick of primary data in the storage using one or more stride of the primary data in one or more dimension of the tensor, load the brick of primary data from the identified location in the storage, determine one or more virtual strides for one or more dimensions of the auxiliary data based on the one or more strides of the primary data, identify a location of the brick of auxiliary data in the storage using the determined one or more virtual strides, and load the brick of the auxiliary data from the identified location in the storage.

The neural processing unit may be configured identify the location of the brick of primary data by multiplying a coordinate of the brick of primary data in a dimension of the tensor by the stride in that dimension. The product of the coordinate and the stride may be added to a base address for the primary data. The neural processing unit may further be configured to identify a location of a brick of auxiliary data by multiplying a coordinate of the brick of auxiliary data in a dimension of the tensor by the virtual stride in that dimension. The product of the coordinate and the virtual stride may be added to a base address for the auxiliary data.

At least one dimension of the tensor may have a stride of one.

Determining the virtual stride from the corresponding stride of the primary data may comprise multiplying or dividing the stride by a factor of two. In such cases, the stride may be stored as binary data. The storage access controller may be configured to determine the virtual stride by bit shifting the stride value.

The primary data may comprise tensor element values. In some implementations, the auxiliary data may comprise scale values. The processor may be configured to multiply the tensor element values by the scale values.

In some implementations, one scale value is provided per predetermined number of tensor element values.

The auxiliary data may comprise sparsity mask values. In such implementations, the tensor element values may represent values of a sparse tensor. The sparsity mask values may indicate locations of the tensor element values in the sparse tensor. A first predetermined number of sparsity mask values may be provided for each second predetermined number tensor element values. The first predetermined number may be greater than the second predetermined number.

The processor may be configured to combine the primary data and auxiliary data to obtain decompressed tensor element values. The auxiliary data may be derived from a fixed-rate compression of the primary data. The primary data may comprise tensor element values. The auxiliary data may comprise auxiliary data element values. In some implementations there may be a predetermined number of auxiliary data element values to each primary data element value.

The processor may be configured to access the primary data and the auxiliary data from respective segments of the tensor. Each segment may a separate start address within the tensor.

The brick of primary data may have a different size in one or more dimensions of the tensor than the brick of auxiliary data. The brick sizes used for the primary data and the auxiliary data may be selected such that the brick sizes have the same size or are a multiple of two in each dimension after account is taken for the mapping between the number of primary data values relative to the number of auxiliary data values.

Each stride may be a multiple of a unit size. The unit size may depend on the format of data stored in the tensor. The unit size may be specified in a description of the tensor stored in the storage.

The one or more stride of the primary data may be stored in the description of the tensor stored in the storage. The virtual strides may not be stored in the description of the tensor. The description of the tensor may further store start addresses for the first segment of the tensor and the second segment of the tensor.

The brick of primary data and brick of auxiliary data may have four or more dimensions. A size of the brick of data in at least one dimension of the tensor may be one.

In some implementations, the storage may be a storage of the processor.

According to a second further embodiment there may be provided a system comprising: the processor of the first further embodiment, implemented in at least one packaged chip; at least one system component; and a board, wherein the at least one packaged chip and the at least one system component are assembled on the board.

A chip-containing product comprising the system of the second further embodiment, wherein the system is assembled on a further board with at least one other product component.

According to a third further embodiment there is provided a method performed by a processor comprising a neural processing unit, wherein the method comprises: obtaining, by a handling unit of the neural processing unit, a description of a task that involves data in a multi-dimensional tensor in a storage; issuing, by the handling unit to a storage access controller, invocation data to read multi-dimensional bricks from the tensor, wherein the multidimensional bricks comprise a brick of primary data read from a first segment of the tensor and a brick of auxiliary data read from a second segment of the tensor; receiving, by the storage access controller, the invocation data from the handling unit; identifying, by the storage access controller, a location of the brick of primary data in the storage using one or more stride of the primary data in one or more dimension of the tensor, loading, by the storage access controller, the brick of primary data from the identified location in the storage, determining, by the storage access controller, one or more virtual strides for one or more dimensions of the auxiliary data based on the one or more strides of the primary data, identifying, by the storage access controller, a location of the brick of auxiliary data in the storage using the determined one or more virtual stride, and loading, by the storage access controller, the brick of the auxiliary data from the identified location in the storage.

In the preceding description, for purposes of explanation, numerous specific details of certain examples are set forth. Reference in the specification to “an example” or similar language means that a particular feature, structure, or characteristic described in connection with the example is included in at least that one example, but not necessarily in other examples.

The above examples are to be understood as illustrative examples of the disclosure. Further examples of the disclosure are envisaged. It is to be understood that any feature described in relation to any one example may be used alone, or in combination with other features described, and may also be used in combination with one or more features of any other of the example, or any combination of any other of the examples. Furthermore, equivalents and modifications not described above may also be employed without departing from the scope of the disclosure, which is defined in the accompanying claims.

What is claimed is:

1. A processor comprising a neural processing unit, wherein the neural processing unit comprises:
a handling unit configured to:
obtain a description of a task that involves data in a multi-dimensional tensor in a storage, and
issue invocation data to a storage access controller to load multi-dimensional bricks from the tensor, wherein the multidimensional bricks comprise a brick of primary data read from a first segment of the tensor and a brick of auxiliary data read from a second segment of the tensor;
the storage access controller configured to:
receive the invocation data from the handling unit;
identify a location of the brick of primary data in the storage using one or more stride of the primary data in one or more dimension of the tensor,
load the brick of primary data from the identified location in the storage,
determine one or more virtual strides for one or more dimensions of the auxiliary data based on the one or more strides of the primary data,
identify a location of the brick of auxiliary data in the storage using the determined one or more virtual strides, and
load the brick of the auxiliary data from the identified location in the storage.

2. A processor according to claim 1, wherein the neural processing unit is configured identify the location of the brick of primary data by multiplying a coordinate of the brick of primary data in a dimension of the tensor by the stride in that dimension.

3. A processor according to claim 1, wherein the neural processing unit is configured to identify a location of a brick of auxiliary data by multiplying a coordinate of the brick of auxiliary data in a dimension of the tensor by the virtual stride in that dimension.

4. A processor according to claim 1, wherein for a dimension of the tensor, the stride is one.

5. A processor according to claim 1, wherein determining the virtual stride from the corresponding stride of the primary data comprises multiplying or dividing the stride by a factor of two.

6. A processor according to claim 5, wherein the stride is stored as binary data and the storage access controller is configured to determine the virtual stride by bit shifting the stride value.

7. A processor according to claim 1, wherein the primary data comprises tensor element values.

8. A processor according to claim 7, wherein the auxiliary data comprises scale values, wherein the processor is configured to multiply the tensor element values by the scale values.

9. A processor according to claim 8, wherein one scale value is provided per predetermined number of tensor element values.

10. A processor according to claim 7, wherein the auxiliary data comprises sparsity mask values, wherein the tensor element values represent values of a sparse tensor, and the sparsity mask values indicate locations of the tensor element values in the sparse tensor.

11. A processor according to claim 10, wherein a first predetermined number of sparsity mask values are provided for each second predetermined number tensor element values, and the first predetermined number is greater than the second predetermined number.

12. A processor according to claim 1, wherein the processor is configured to combine the primary data and auxiliary data to obtain decompressed tensor element values.

13. A processor according to claim 1, wherein the processor is configured to access the primary data and the auxiliary data from respective segments of the tensor, wherein each segment has a separate start address within the tensor.

14. A processor according to claim 1, wherein the brick of primary data has a different size in one or more dimensions of the tensor than the brick of auxiliary data.

15. A processor according to claim 1, wherein each stride is a multiple of a unit size, the unit size depends on the format of data stored in the tensor, and the unit size is specified in a description of the tensor stored in the storage.

16. A processor according to claim 1, wherein the one or more stride of the primary data is stored in a description of the tensor stored in the storage.

17. A processor according to claim 1, wherein the brick of primary data and brick of auxiliary data have four or more dimensions and a size of the brick of data in at least one dimension of the tensor is one.

18. A system comprising:
the processor of claim 1, implemented in at least one packaged chip;
at least one system component; and
a board,
wherein the at least one packaged chip and the at least one system component are assembled on the board.

19. A chip-containing product comprising the system of claim 18, wherein the system is assembled on a further board with at least one other product component.

20. A method performed by a processor comprising a neural processing unit, wherein the method comprises:
obtaining, by a handling unit of the neural processing unit, a description of a task that involves data in a multi-dimensional tensor in a storage;
issuing, by the handling unit to a storage access controller, invocation data to read multi-dimensional bricks from the tensor, wherein the multidimensional bricks comprise a brick of primary data read from a first segment of the tensor and a brick of auxiliary data read from a second segment of the tensor;
receiving, by the storage access controller, the invocation data from the handling unit;
identifying, by the storage access controller, a location of the brick of primary data in the storage using one or more stride of the primary data in one or more dimension of the tensor,
loading, by the storage access controller, the brick of primary data from the identified location in the storage,
determining, by the storage access controller, one or more virtual strides for one or more dimensions of the auxiliary data based on the one or more strides of the primary data,
identifying, by the storage access controller, a location of the brick of auxiliary data in the storage using the determined one or more virtual stride, and
loading, by the storage access controller, the brick of the auxiliary data from the identified location in the storage.
